(19) United States
(12) Patent Application Publication
(10) Pub. No.: US 2005/0205182 A1
(43) Pub. Date: Sep. 22, 2005

(54) Tyre self-sealing device for the wheel of a vehicle

(75) Inventors: Michel Maquaire, Ardon (FR); David Adrion, Le Coteau (FR)

Correspondence Address: PARKHURST & WENDEL, L.L.P., 1421 PRINCE STREET, SUITE 210, ALEXANDRIA, VA, 22314-2805, US

(73) Assignee: Syegon, Versailles (FR)

(21) Appl. No.: 10/509,154

(22) PCT Filed: Mar. 20, 2003
(86) PCT No.: PCT/FR03/00894

§ 371 Date: Sep. 28, 2004

(30) Foreign Application Priority Data
Mar. 29, 2002 (FR) 02.04031

(51) Int. Cl. B60C 29/00

(52) U.S. Cl. 152/417

(57) ABSTRACT

A self-sealing device for a tire on a vehicle wheel, including a wheel, a wheel hub supporting the wheel, a wheel supply circuit, an inflating and deflating valve for supplying compressed air from a pressurized circuit, wherein the valve is positioned between the wheel and the wheel hub and includes sealing means integrated into the wheel supply circuit, wherein the sealing means is activatable to an open position in the presence of the valve and to a closed position in the absence of the valve.

### BACKGROUND OF THE INVENTION

1. Field of Invention

The technical scope of the present invention is that of inflation and deflation systems for a vehicle wheel.

2. Description of the Related Art

The principle of valves enabling the inflation and deflation of vehicle tires by remote control is known, notably by patents FR-2667826 and FR-2731655.

In the scope of application above-mentioned, it is known for the valve system to be particularly well adapted to heavy equipment, such as lorries, military vehicles, public works or civil security vehicles. This system has to be adapted when applied to light vehicles.

The drawback to this system in the case of light vehicles lies firstly in the fact that operations to dismount the wheel and/or the valve always result in the deflation of the tire, thereby making wheel balancing operations both problematic and uncertain. The user or the constructor is thus obliged to install an isolating valve to avoid having to reinflate the wheel.

Another drawback lies in the fact that the valve and its connection remain accessible from the exterior and are subject to theft and deliberate deterioration (vandalism) or accidental deterioration (shocks to the wheel rim).

Another drawback lies in the fact that since the system is off-centre with respect to the wheel's axis of spin it is subjected to high centrifugal forces because of the high spin rate which is prejudicial to its functioning.

Lastly, fastening the valve to the wheel rim requires drill holes to be made thereby weakening the wheel rim.

### SUMMARY OF THE INVENTION

The aim of the present invention is to propose a new manner to integrate a valve in a wheel allowing the inflation pressure in the tire to be maintained during mounting or dismounting of the wheel and/or the valve.

The invention thus relates to a tire self-sealing device for a vehicle wheel equipped with a tire inflating and deflating valve that ensures a supply of compressed air by means of a pressurised circuit, wherein the valve is positioned between the wheel and the wheel hub and wherein it comprises sealing means integrated into the wheel supply circuit, said means being activated in the open position in the presence of the valve and in the closed position in the absence of the valve.

The open position designates a state of the sealing element in which air is able to pass from valve to tire or from tire to valve.

Advantageously, the sealing means are constituted by a finger extended by a truncated cone-shaped part able to move under the action of a spring inside a bore made in the wheel supply circuit, the truncated cone-shaped part able to be applied against a seat having a cone-shaped profile under the action of a spring to close the wheel supply circuit.

It is obvious that the truncated cone-shape is taken here as an example. Other means, such as a plane or spherical shape may be envisaged, but for the sake of clarity, it is this example which will be used to explain the principle behind the invention.

Advantageously again, the valve, constituted of a valve body and a bonnet, forms a case delimited by the hub and the seat, both fitted with communication means to enable the provision of compressed air to the wheel from a revolving joint, the seat being placed on the wheel and the valve bonnet on the hub supporting the wheel.

Advantageously again, the valve is positioned such that is axis of symmetry is the same as the wheel's axis of spin.

According to one characteristic, the sealing means are arranged so as to act axially with respect to the wheel.

Advantageously, the valve is screwed into the hub.

Advantageously again, the seat is provided with an indexing organ with respect to the hub; the indexing, or locating, organ may, for example, be a pin or screw.

According to one characteristic, the sealing means are always placed so as to act axially but the valve is fastened to the wheel rim by pressure screws.

According to another characteristic, the sealing means are positioned to act radially with respect to the wheel.

Advantageously, the valve seat is extended by a substantially truncated cone-shaped part intended to cooperate with the sealing means, the extension being fitted with communication means between valve and wheel; the wheel is closed to the exterior.

Advantageously, the valve is held in the seat by friction. By friction we mean a relation enabling the valve to be easily inserted into the bore (for example a pivoting sliding relation) but for which an O-ring ensures the sealing of the assembly.

Advantageously again, the seat is extended by a substantially cylindrical part capped by a plug with a truncated cone-shaped part intended to cooperate with the sealing means, the plug being screwed onto said extension; the wheel is open to the exterior.

Another advantage lies in the fact that such an assembly allows the gradual depressurization of the volumes located between the seal and the valve when this is being dismounted.

A first advantage of the present invention lies in the fact that the tire pressure is maintained even when the wheel or the valve have been dismounted.

Another advantage lies in the possibility of performing balancing operations without the tricky dismounting of the valve, balancing being carried out by any type of apparatus.

Another advantage lies in the quick and easy dismounting of the valve after dismounting the wheel.

Yet another advantage of the invention lies in the fact that the whole system is inaccessible by the exterior, thereby preventing the valve from being deteriorated.

Yet another advantage lies in the fact that the central position of the valve makes it relatively insensitive to the centrifugal forces, thereby improving its reliability and life time.

Yet another advantage lies in the technical aspect of easy mounting and minor modification to be made to the wheel or its support.

Advantageously again, the system is totally sealed so long as the sealing means are not closed.

### BRIEF DESCRIPTION OF THE DRAWINGS

Other characteristics, particulars and advantages of the invention will become apparent from the following description of the different embodiments made by way of illustration and in reference to the drawings, in which:

FIG. 1 is a diametral section of the wheel and all its components according to a first configuration,

FIG. 2 is an enlarged partial view of FIG. 1,

FIG. 3 is a partial section showing an embodiment of the sealing means,

FIG. 4 is a partial section showing another variant embodiment of the invention,

FIG. 5 is a partial section showing another variant embodiment of the invention, and

FIG. 6 is a partial section showing another mounting variant for the valve.

### DETAILED DESCRIPTION OF PREFERRED EMBODIMENTS

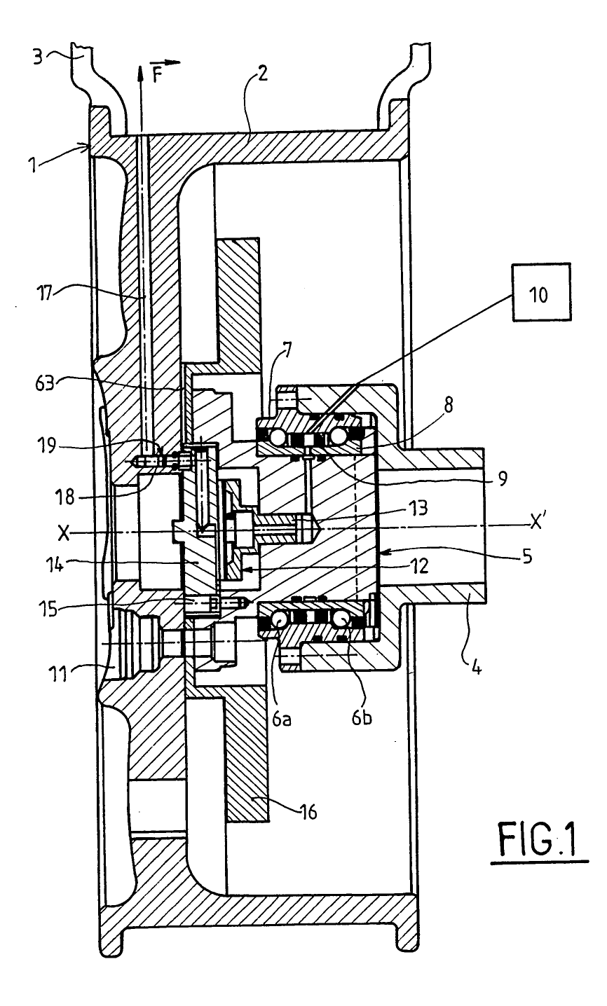

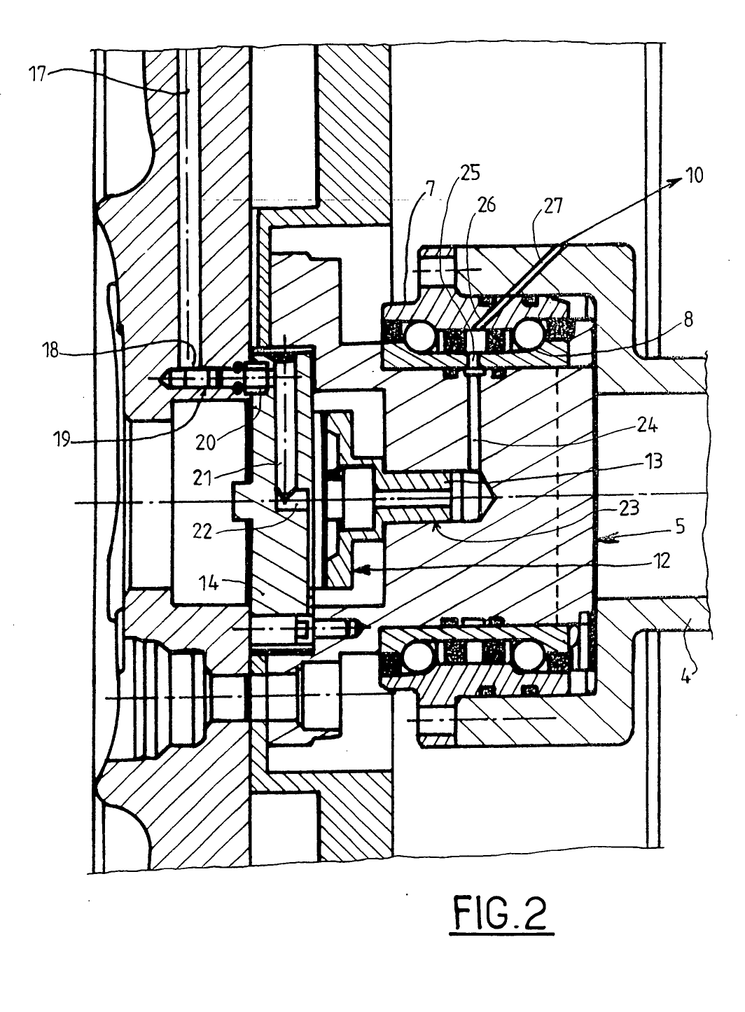

FIG. 1, which represents a section of a wheel mounted on its drive shaft, shows the wheel 1 constituted of a wheel rim 2 and a tire 3. The wheel rim 2 is connected to its support shaft 4 by means of a hub 5. Two bearings 6a and 6b are classically positioned between the shaft 4 and the hub 5. These bearings classically comprise an external housing 7 and an internal housing 8 between which is placed a revolving joint 9 to allow pressurised fluid to pass between an external source 10 and the tire 3 as will be explained hereafter in reference to FIG. 2. The wheel rim 2 is classically mounted on the hub by means of bolts whose housing 11 can be seen in the Figure. A valve 12 is mounted in the hub 5 and according to the invention comprises a valve bonnet 13 screwed into the hub and a seat 14, the valve being indexed with respect to the hub by means of a screw 15. This screw allows the valve 12 to be indexed with respect to the hub to ensure the continuity of the fluid circuit as will be explained after. The Figure also shows a brake disc 16 integral with the hub 5. The brake disc has grooves 63 allowing air to escape, in accordance with the functioning of the valve explained in the afore-mentioned patents.

The wheel rim 2 is provided with a radial duct 17 and an axial duct 18 allowing fluid to communicate between the valve 12 and the tire 3 following arrow F. The term radial duct will be used when the duct is arranged if a perpendicular direction to the axis of spin XX′ of the hub 5 and axial direction when the duct is arranged in a parallel direction the axis XX′. According to the invention, sealing means 19 are provided positioned in the axial duct 18, intended to cooperate with the seat 14 of the valve. The sealing means thus occupy an axial position in this configuration and are in the open position.

FIG. 2, which represents an enlarged partial view of FIG. 1, shows that the fluid circuit between the source 10 and the tire comprises, in addition to ducts 17 and 18, a first axial duct 20 extended by a radial duct 21 and a second axial duct 22 made in the seat 14, an axial bore 23 and a radial duct 24 made in the hub 5, a slot 25 dividing the internal housing 8 into two parts, a duct 26 made in the external housing 7 and a duct 27 made in the shaft 4. Naturally, these different ducts are intended to inter-link when these different elements are mounted. The bore 23 is threaded to screw in the valve 12. Thus, when mounting, the valve bonnet 13 is firstly screwed into the bore 23 in the hub, then the wheel is positioned on the hub and the sealing means installed in the open position pressing on the seat 14, as shown in the Figure.

The fluid circuit operates as follows. To supply the tire 3 with pressurised fluid from the source 10, the passage of air is activated which will successively pass through duct 27, the revolving joint 9, the slot 25, duct 24, the valve 12, ducts 22, 21 and 20, the sealing means 19 which are in the open position, duct 18 and lastly duct 17. If the tire 3 needs to be deflated, the circuit previously described is activated in depression using suitable means.

The inflating and deflating control means may be those described in patent FR-2731655. They may be used as such without any significant modification. It is thus unnecessary to describe them in detail.

Naturally, seals are provided to avoid any leakage and to maintain the pressure in the tire at the required value.

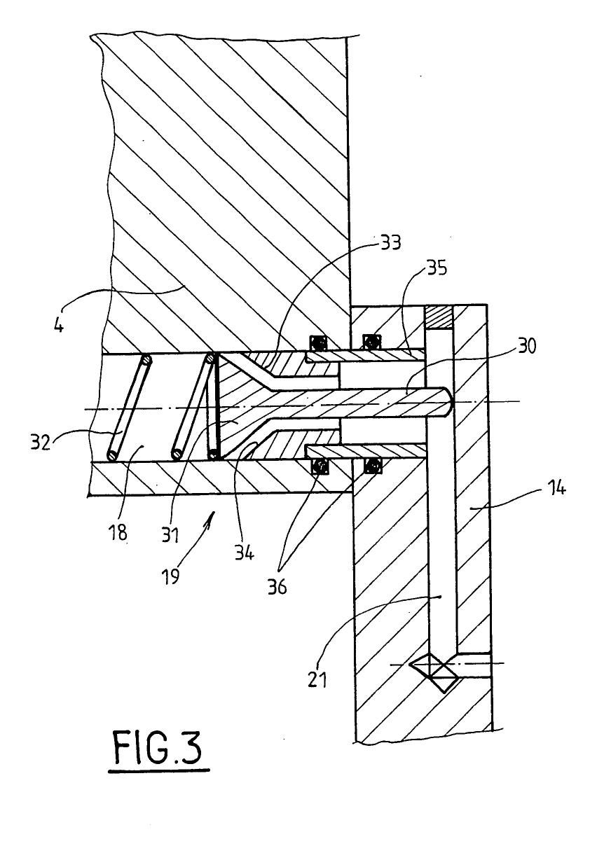

FIG. 3 shows a section of an embodiment of the sealing means 19. This comprises a pin 30 whose free end presses on the seat 14 and which is extended at its other end by a truncated cone-shaped part 31 on which an elastic element 32, for example a helicoidal spring, acts. This spring 32 is, for example, applied against the bottom of duct 18. At the mouth of duct 18, a retainer 33 has a flared part 34 of the same configuration as part 31. The retainer 33 is held in place by an insert 35 fixed on the wheel rim 4. O-rings 36 are integrated in the wheel rim 4 and the seat 14 to ensure sealing between the insert 35, the wheel rim 4 and the seat 14. Operation is as follows.

The seal 19 only lets air through (in one direction or another) when the seat 14 activates the finger 30, that is to say, when the valve is mounted on the wheel rim, thereby allowing the circulation of air between duct 21 coming from valve 12 and duct 17 communicating with the tire 3. When the wheel rim is dismounted, the spring 32 pushes the finger 30 towards the exterior of the drill hole 18 so that part 31 comes into close contact with conical surface 34. In this configuration, the tire 3 is held under pressure by closing the circuit and the balancing operations or interventions on the means can be carried out without loss of pressure. One of the roles of the insert 35 is to ensure the imperviousness of the system between the moment when the finger 30 is activated and the moment when the valve is fixed in an airtight manner to the wheel rim. Similarly, during dismounting, the insert 35 ensures the imperviousness of the system between the start of dismounting and the moment when part 31 ensures the full closure of the seal.

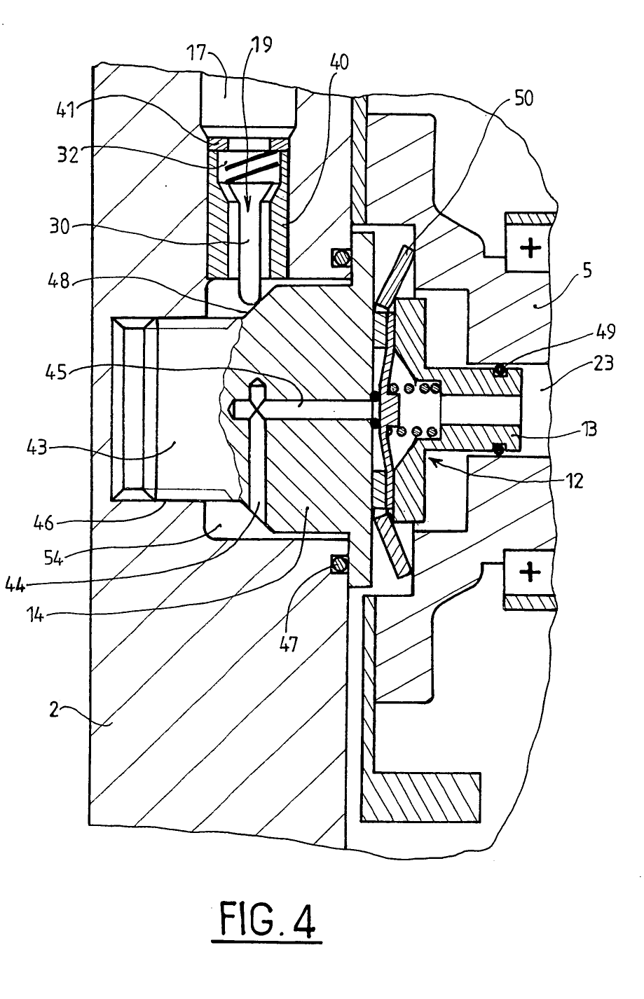

FIG. 4 shows a variant embodiment in which the sealing means are positioned radially. The finger 30 is placed in the radial duct 17 as is a retainer 40 having a conical surface 17. The seat 14 is extended by a threaded part 43 able to be screwed onto the wheel rim 2 in a bore 46 closed on the exterior and is provided with a ramp 48 on which the finger 30 presses. This seat 14 is pierced by a radial duct 44 and an axial duct 45 that inter-link. The radial duct 44 communicates with a chamber 54 delimited by the wheel rim 2 and the seat 14, which in turn communicates with the radial duct 17. The axial duct 45 communicates with the valve body 13. This valve is classically isolated in its housing in the hub 5, for example by means of an O-ring 49. An O-ring 47 inserted in a housing made in the wheel rim ensures imperviousness between it and the seat 14. In this configuration, the wheel rim is completely closed with no hold on the valve 12 which is fixed to it by screwing its threaded part 43 in the bore 46. The assembly is in this case more compact than for the previous case. The valve no longer needs to be indexed. In the Figure, a washer 50, of the Belleville type, acts as a flange for the valve 12 and keeps it in position. In this embodiment, the valve 12 is not screwed in the hub 5 but is linked by friction in the bore 23.

Operation is as follows. When the wheel rim is dismounted, the valve remains fastened to it and merely needs to be unscrewed to be separated from the wheel rim for balancing operations to be carried out. As the valve is being unscrewed, the finger 30 travels along the ramp 48 and comes to press against the cone-shaped surface of the retainer 40 closing the fluid circuit. Similarly, when the valve is being screwed in, the finger 30 travels along the ramp 48 away from the cone-shaped surface of the retainer 40 opening the fluid circuit.

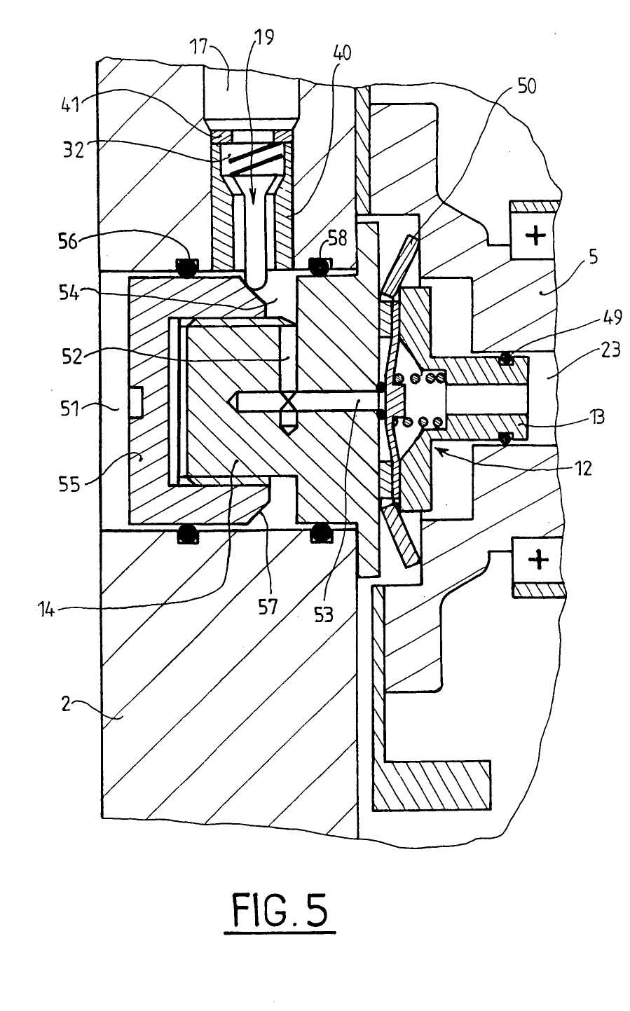

FIG. 5 shows the assembly of a valve 12 having a configuration identical to that in FIG. 4 with the exception of the seat 14. In this embodiment, the wheel rim 2 is open to the exterior, that is to say it has a hole 51 aligned with the bore 23 in the hub. The seat 14 is pierced by a radial duct 52 and an axial duct 53 that are inter-linking. As in the previous case, duct 53 communicates with the valve 12 and duct 52 communicates with a chamber 54 delimited by the wheel rim 2, the seat 14 and a cap 55. This cap is screwed onto the end of the bonnet and adjusted in the wheel rim 2 and sealed using an O-ring 56. This cap incorporates a ramp 57 onto which the seal finger comes into contact. This cap thus seals the chamber 54 with respect to the exterior and also retains the opening of the seal 19. Another O-ring 58 ensures the sealing between the seat 14 and the wheel rim 2. The valve 12 is fixed onto the wheel rim by friction and it is the cap 55 which ensures its partial fastening. This fastening is enough to retain the valve and to protect it from stresses during handling operations. Full fastening is obtained using an elastic element 50 of the Belleville washer type. The valve body is also fixed by friction in the hub 5.

Assembly is as follows. Firstly, the valve 12 is introduced into the wheel rim 2, and then the cap 55 is screwed onto the bonnet. As it is being screwed on, by three threads for example, the ramp 57 pushes the finger of the seal 19 which opens the tire supply circuit. The system is ready to function and the wheel may be mounted on the hub. Slightly loosening the cap (a few turns) allows the circuit to be closed whilst holding the valve in position.

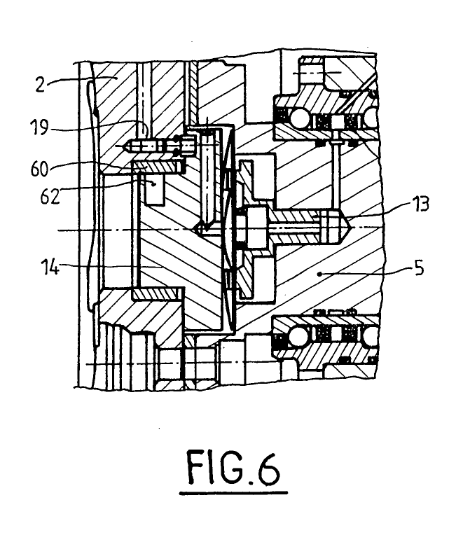

A variant embodiment is shown in FIG. 6 as an addition to the embodiment shown in FIG. 1. In this embodiment, the valve 12 is fastened not on the hub 5 but on the wheel rim 2. The valve seat 14 is fastened to the wheel rim 2 by means of a tubular insert 60 on the wheel rim. The bonnet is fastened using appropriate linking element, for example three pressure screws in housings 62 adapted to this type of fastening.

The valve 12 is then housed in the bore in the hub 5, where it is held by friction. An elastic element, of the Belleville washer type, provides flanging for the valve 12.

The invention is not limited to the examples described and shown since various modifications may be made without departing from its scope.

1. A self-sealing device for a tire on a vehicle wheel, said device comprising:
a wheel having a rim;
a wheel hub supporting said wheel;
a wheel supply circuit;
an inflating and deflating valve for supplying compressed air from a pressurized circuit, wherein said valve is positioned between said wheel and the wheel hub and comprises sealing means integrated into said wheel supply circuit, said sealing means activatable to an open position in the presence of said valve and to a closed position in the absence of said valve.

2. The self-sealing device according to claim 1, wherein said wheel supply circuit comprises a bore, and said sealing means comprise:
a spring;
a first seat having a cone-shaped profile;
a finger extended by a truncated cone-shaped part and movable responsive to action of the spring inside said bore, said truncated cone-shaped part movable against said first seat responsive to action of the spring to close said wheel supply circuit.

3. The self-sealing device according to claim 2, further comprising a revolving joint and communication means, wherein said valve comprises a valve bonnet and a second seat, said valve defining a chamber delimited by said hub and the bonnet, said hub and said bonnet being attached to the communication means for supplying compressed air to said wheel through said revolving joint, the said second seat being located on said wheel and said valve bonnet on said wheel hub.

4. The self-sealing device according to claim 3, wherein the axis of symmetry of said valve is the same as the axis of spin of said wheel.

5. The self-sealing device according to claim 4, wherein said sealing means are arranged so as to act axially with respect to said wheel.

6. The self-sealing device according to claim 5, wherein said valve is screwed into said wheel hub.

7. The self-sealing device according to claim 6, wherein said second seat comprises an indexing organ indexable with respect to said hub.

8. The self-sealing device according to claim 7, wherein said indexing organ is a screw.

9. The self-sealing device according to claim 4, wherein said sealing means are placed to act radially with respect to said wheel.

10. The self-sealing device according to claim 9, wherein:
said second valve seat is extended by a substantially truncated cone-shaped part having a surface cooperating with said sealing means, said cone-shaped part comprising said communication means located between said valve and said wheel, and
said wheel rim defines a closed seal with respect to an area external to the wheel.

11. The self-sealing device according to claim 10, wherein said valve bonnet is held in said hub by friction.

12. The self-sealing device according to claim 9, further comprising a substantially cylindrical part capped by a plug having a ramp for cooperating with said sealing means, wherein said second seat is extended by a said cylindrical part said plug being screwed onto said part, and said wheel being open an area external to the wheel.

13. The self-sealing device according to claim 10, further comprising a chamber delimited by said wheel rim and said second seat, wherein said device comprises sealing means positioned to ensure a gradual depressurization of said chamber when said valve is dismounted.

14. The self-sealing device according to claim 5, wherein said second seat is fastened to said wheel rim.

15. The self-sealing device according to claim 14, wherein said wheel rim is provided with a tubular insert onto which said valve is fastened using pressure screws.

16. The self-sealing device according to claim 1, further comprising locating means for positioning said wheel to ensure sealing until said sealing means are completely closed.
